(19) United States
(12) Patent Application Publication
(10) Pub. No.: US 2021/0104391 A1
(43) Pub. Date: Apr. 8, 2021

(54) INORGANIC MASS SPECTROMETER

(71) Applicant: SHAN JIANG, BEIJING CITY (CN)

(72) Inventor: SHAN JIANG, BEIJING CITY (CN)

(21) Appl. No.: 16/706,937

(22) Filed: Dec. 9, 2019

(30) Foreign Application Priority Data
Oct. 8, 2019 (CN) 201910948022.3

(51) Int. Cl. H01J 49/06; H01J 49/02

(52) U.S. Cl. CPC H01J 49/061; H01J 49/025

(57) ABSTRACT

The present invention discloses an inorganic mass spectrometer, which is an inorganic mass spectrometer based on a multi-charge state ion source. The specific structure comprises: a multi-charge state ion source, a front-end analysis system, a back-end analysis system, and an ion detector. The multi-charge state ion source is connected with the front-end analysis system, the front-end analysis system is connected with the back-end analysis system, and the back-end analysis system is connected with the ion detector. The instrument has the ability of eliminating the molecular background and reducing the isobaric heterotope background, and also has advantages of a strong beam, high transmission efficiency and the like, thereby significantly improving the abundance sensitivity and accuracy of the inorganic mass spectrometer measurement.

### TECHNICAL FIELD

The present invention relates to the field of mass spectrometry instruments, and in particular, to an inorganic mass spectrometer.

### BACKGROUND

The existing inorganic mass spectrometer is composed of an ion source system, an analyzer system (mainly including an electrostatic analyzer, a magnetic analyzer, a flight time analyzer, a quadrupole analyzer, and the like), and an ion detector system. In the measurement of the inorganic mass spectrometer, due to the interference of molecular ion background and isobaric heterotope ion background, the sensitivity of inorganic mass spectrometer is affected, and the minimum detection limit can be in the range of 10⁻¹² g/g, reaching a trace analysis range. The measurement accuracy is up to 0.5%.

Due to the in-depth development of materials, nuclear energy, environment, geology, biomedicine, archaeology, oceanography, and the like, it is necessary to improve the measurement sensitivity and measurement accuracy of elements. The minimum detection limit is reduced from 10⁻¹² g/g to 10⁻¹³-10⁻¹⁷ g/g, that is, up to the ultra-trace range. The measurement accuracy requirement has increased from 0.5% to less than 0.1%. Currently, the measurement sensitivity and accuracy of the inorganic mass spectrometer are far from meeting the demands of measurement.

### SUMMARY

An object of the present invention is to provide an inorganic mass spectrometer, to improve the measurement sensitivity and accuracy of the inorganic mass spectrometer.

To achieve the above purpose, the present invention provides the following technical solution.

An inorganic mass spectrometer includes:

a multi-charge state ion source, used for generating a strong current ion beam of multivalent charge states (3+ or over 3+), where the strong current ion beam includes: a constant particle beam, a micro particle beam, a trace particle beam, and an ultra-trace particle beam, and the ultra-trace particle beam includes an ultra-trace isotope and an ultra-trace background;

a front-end analysis system, connected with the multi-charge state ion source and used for screening the constant particle beam, the micro particle beam, and the trace particle beam, absorbing and measuring the constant particle beam, the micro particle beam, and the trace particle beam, and outputting the ultra-trace particle beam;

a back-end analysis system, connected with the front-end analysis system and used for eliminating the ultra-trace background in the ultra-trace particle beam; and

an ion detector, connected with the back-end analysis system and used for receiving the ultra-trace isotope and measuring the ultra-trace isotope.

Optionally, the multi-charge state ion source is a cyclotron resonance ion source, and can generate a strong current ion beam of multivalent charge states (3+ or over 3+) for all elements from H to Pu, actinide elements, and transactinide elements.

Optionally, the front-end analysis system includes:

an accelerating section, connected with the multi-charge state ion source and used for accelerating the strong current ion beam;

a front-end analyzer, respectively connected with the accelerating section and the back-end analysis system, and used for separating the constant particle beam, the micro particle beam, and the trace particle beam from the ultra-trace particle beam, and outputting the ultra-trace particle beam into the back-end analysis system; and

an ion receiver, disposed at an output end of the front-end analyzer and used for absorbing and measuring the constant particle beam, the micro particle beam, and the trace particle beam.

Optionally, the accelerating section is a strong current single-stage electrostatic accelerating tube, and the accelerating tube has a beam intensity in a range of 0.1 μA-5000 μA, and an operating voltage of 10 kV-400 kV.

Optionally, the front-end analyzer is any one or a combination of any two of a magnetic analyzer, an electrostatic analyzer, a quadrupole analyzer, or a flight time analyzer.

Optionally, the ion receiver is a set of Faraday cups.

Optionally, the back-end analysis system includes: a first electrostatic analyzer, an energy absorption film, a magnetic analyzer, and a second electrostatic analyzer, where an input end of the first electrostatic analyzer is connected with an output end of the front-end analysis system, and the energy absorption film is fixed between an output end of the first electrostatic analyzer and an input end of the magnetic analyzer; and an output end of the magnetic analyzer is connected with an input end of the second electrostatic analyzer, and an output end of the second electrostatic analyzer is connected with the ion detector.

Optionally, the back-end analysis system includes: an electrostatic analyzer, an energy absorption film, and a speed selector, where an input end of the electrostatic analyzer is connected with an output end of the front-end analysis system, and the energy absorption film is fixed between an output end of the electrostatic analyzer and an input end of the speed selector; and an output end of the speed selector is connected with the ion detector.

Optionally, the ion detector is a solid detector or a gas detector.

According to specific embodiments provided in the present invention, the present invention discloses the following technical effects:

First, the measurement sensitivity is improved. The inorganic mass spectrometer of the present invention uses a multi-charge state ion source, does not generate interference of the molecular background, and significantly improves the measurement sensitivity. The minimum detection limit can be in the range of 10⁻¹³-10⁻¹⁷ g/g, which is 10¹-10⁵ times lower than 10⁻¹² g/g of the conventional inorganic mass spectrometer. The content of elements measured by the conventional inorganic mass spectrometer belongs to a micro-trace range. The measurement range of the inorganic mass spectrometer based on the multi-charge state ion source of the present invention belongs to an ultra-trace range.

Second, the measurement accuracy is improved. The inorganic mass spectrometer of the present invention uses a multi-charge state ion source, with a beam range of 10²-10³ μA. For the measurement of trace and ultra-trace elements, the transmission efficiency can reach more than 30%. This is 10-100 times higher than the beam and counting rate of the conventional high-precision inorganic mass spectrometer. Therefore, the measurement accuracy is significantly improved, and the measurement accuracy can be less than 0.1% for trace elements (10⁻⁹ g/g).

Third, the ability of eliminating various backgrounds is improved. Due to the use of multi-charge states, the energy of the ions is improved (the energy of the ions is equal to the product of the number of charge states and the accelerating voltage). After the energy is improved, it is advantageous to eliminate the interference of the isobaric heterotope backgrounds, which is beneficial to reduce the interference of the scattering background and to improve the energy fraction of the detector, thereby improving the measurement sensitivity.

Fourth, the dosage of the sample is reduced. The multi-charge state ion source used has strong beam, and the beam is strong because the ionization efficiency of the sample is high. Therefore, the dosage of the sample is small in order to achieve the same measurement and statistical accuracy.

### BRIEF DESCRIPTION OF THE DRAWINGS

To describe the technical solutions in the embodiments of the present invention or in the prior art more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic structural diagram of an inorganic mass spectrometer of the present invention.

### REFERENCE NUMERAL DESCRIPTION

1 represents a multi-charge state ion source, 2-1 represents an accelerating section, 2-2 represents a front-end analyzer, 2-3 represents an ion receiver, 3-1 represents an electrostatic analyzer, 3-2 represents an energy absorption film, 3-3 represents a speed selector, and 4 represents an ion detector.

### DETAILED DESCRIPTION

The following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

There are three main factors that affect the measurement sensitivity and accuracy of the inorganic mass spectrometer, the first one is the level of the molecular background and the isobaric heterotope background; the second one is the transmission efficiency of ions; and the third one is the beam intensity of the ion source. Among the three factors, the level of the molecular background and the isobaric heterotope background is the most important factor of affecting the sensitivity, and the transmission efficiency and the beam intensity of the ion source are main factors of affecting the accuracy.

In order to improve the measurement sensitivity and measurement accuracy, the present invention studies the main problems affecting the measurement sensitivity and measurement accuracy of the inorganic mass spectrometer, that is, problems of the molecular background and the isobaric heterotope background, problems of the ion transmission efficiency and the ion source beam intensity: an inorganic mass spectrometer based on a multi-charge state ion source, MCI-MS, was first proposed.

To make the foregoing objective, features, and advantages of the present invention clearer and more comprehensible, the present invention is further described in detail below with reference to the accompanying drawings and specific embodiments.

### Embodiment

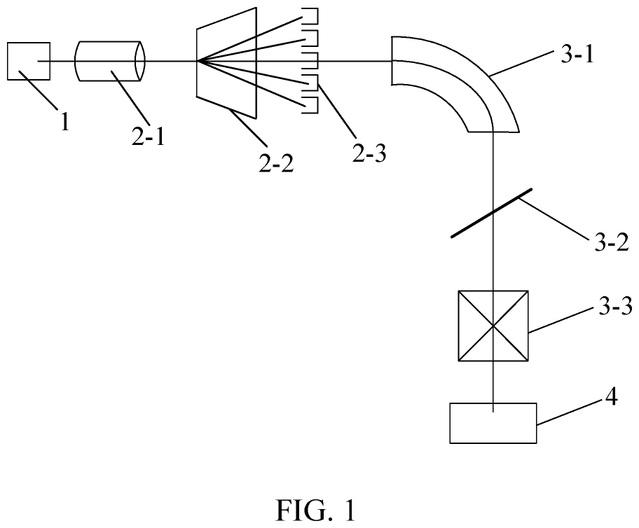

As shown in FIG. 1, the inorganic mass spectrometer of the present invention includes a multi-charge state ion source 1, a front-end analysis system, a back-end analysis system, and an ion detector 4.

The multi-charge state ion source 1 is connected with the front-end analysis system; the front-end analysis system is connected with the back-end analysis system; and the back-end analysis system is connected with the ion detector 4.

The multi-charge state ion source 1 is used for generating strong current ion beams of multivalent charge states such as 3+, 4+ and the like. The strong current ion beam includes: a constant particle beam, a micro particle beam, a trace particle beam, and an ultra-trace particle beam, and the ultra-trace particle beam includes an ultra-trace isotope and an ultra-trace background.

For example, for CO₂, ions such as C⁺, C²⁺, C³⁺, C⁴⁺, C⁵⁺, C⁶⁺ and the like can be generated. C²⁺ and C⁺ are respectively a double-charge state and a single-charge state, C³⁺, C⁴⁺, and C⁵⁺ are multi-charge states, and C⁶⁺ is a high-charge state or a fully-peeling state.

Currently, there are two main types of ion sources capable of extracting the multi-charge state, one is an electron cyclotron resonance ion source (ECR), and the other is a high frequency spark discharge ion source (HF).

In this application, the multi-charge state ion source is an electron cyclotron resonance ion source, which can generate strong current ion beams of multivalent charge states such as 3+, 4+ or the like for all elements from H to Pu, actinide elements, and transactinide elements. Due to the high production efficiency of multi-charge state and good beam quality, the ECR ion source currently is the preferred ion source of MCI-MS. The microwave frequency of the ion source is in the range of 5 GHz-25 GHz. The microwave frequency in this range is the optimal frequency for generating multiple charge states. In addition, the ECR ion source is gas injection, which reduces many sample preparation processes and reduces the contamination caused by the sample preparation processes.

The front-end analysis system is used for selecting and separating the strong current ion beam, screening the constant particle beam, the micro particle beam, and the trace particle beam, absorbing and measuring the constant particle beam, the micro particle beam, and the trace particle beam, and outputting the ultra-trace particle beam.

The front-end analysis system includes:

an accelerating section, connected with the multi-charge state ion source and used for accelerating the strong current ion beam;

a front-end analyzer, respectively connected with the accelerating section and the back-end analysis system, and used for separating the constant particle beam, the micro particle beam, and the trace particle beam from the ultra-trace particle beam, and outputting the ultra-trace particle beam into the back-end analysis system; and

an ion receiver, disposed at an output end of the front-end analyzer and used for absorbing and measuring the constant particle beam, the micro particle beam, and the trace particle beam.

In this embodiment, the accelerating section 2-1 has no gas or solid stripper component, and is a strong current single-stage electrostatic accelerating tube. The accelerating tube has a beam intensity in a range of 0.1 μA-5000 μA, and an operating voltage of 10 kV-400 kV, for increasing the energy of the ions such that the ions pass through the front end analyzer to obtain good mass resolution.

The front-end analyzer is any one of a magnetic analyzer, an electrostatic analyzer, a quadrupole analyzer, or a flight time analyzer, or may be a combination of any two of the above four analyzers.

The ion receiver 2-3 is a set of movable Faraday cups, usually 3-7 Faraday cups, and the position of each Faraday cup can be changed.

The back-end analysis system is used to eliminate the interference of the ultra-trace background in the ultra-trace particle beam, so as to analyze the ultra-trace elements (10⁻¹³-10⁻¹⁷ g/g); the ultra-trace background includes isobaric heterotope ions and ions having the same charge-to-mass ratio as the ultra-trace isotope. For example, 14C radioactive impurities in materials are measured, 14C⁴⁺ ions are selected, there is an interference from the isobaric heterotope 14N⁴⁺, and there is also an interference from ions having the same charge-to-mass ratio (e.g., 7Li²⁺. 21Ne⁶⁺ and the like). The device is capable of effectively eliminating these ultra-trace backgrounds.

The back-end analysis system includes an electrostatic analyzer 3-1, an energy absorption film 3-2, and a speed selector 3-3.

An input end of the electrostatic analyzer 3-1 is connected with an output end of the front-end analysis system, and the energy absorption film 3-2 is fixed between an output end of the electrostatic analyzer 3-1 and an input end of the speed selector 3-3; and an output end of the speed selector 3-3 is connected with the ion detector.

The speed selector 3-3 may be replaced by a magnetic analyzer and a second electrostatic analyzer, and then the back-end analysis system specifically includes: a first electrostatic analyzer, an energy absorption film, a magnetic analyzer, and a second electrostatic analyzer. An input end of the first electrostatic analyzer is connected with an output end of the front-end analysis system, and the energy absorption film is fixed between an output end of the first electrostatic analyzer and an input end of the magnetic analyzer; and an output end of the magnetic analyzer is connected with an input end of the second electrostatic analyzer, and an output end of the second electrostatic analyzer is connected with the ion detector.

The energy absorption film is a nano-scale uniform film or a gas chamber. After ions pass through the energy absorption film (or gas), first, the isobaric heterotope (e.g., 14C⁴⁺ and 14N⁴⁺) with same energy has different energy loss on the film (or gas); and second, ions with the same nucleo-cytoplasmic ratio (e.g., 14C⁴⁺, 7Li²⁺, 21Ne⁶⁺, 28Si⁸⁺ or the like) have a large difference in energy loss on the film (or gas). Both of the above cases can be identified and eliminated by the electrostatic analyzer, magnetic analyzer or speed selector of the back-end analyzer.

The ion detector 4 is a solid detector or a gas detector. The solid detector is a thin-window (10 nm-50 nm) or windowless solid detector, and the gas detector is a thin-window (30 nm-50 nm SiN materials) gas detector.

The ion detector 4 of this application includes a solid detector or gas detector with high energy resolution, and an electron sink and data acquisition components. After the ultra-trace particle beams pass through the back-end analyzer, the interferences from the isobaric heterotope ions and ions having the same charge-to-mass ratio as the ultra-trace isotope cannot be completely eliminated. By virtue of the characteristic that the energy of these interfering ions is obviously different from that of the ultra-trace isotope, through the measurement carried out by the high-energy-resolution and charge resolution detector, the background interferences can be further identified and eliminated.

The inorganic mass spectrometer is an inorganic mass spectrometer based on a multi-charge state ion source. The specific structure includes: a multi-charge state ion source, a front-end analysis system, a back-end analysis system, and an ion detector. The multi-charge state ion source is connected with the front-end analysis system, the front-end analysis system is connected with the back-end analysis system, and the back-end analysis system is connected with the ion detector. The instrument has the ability of eliminating the molecular background and reducing the isobaric heterotope background, and also has advantages of a strong beam, high transmission efficiency, and the like. The measurement sensitivity and measurement accuracy of the inorganic mass spectrometer are significantly improved.

Each embodiment of the present specification is described in a progressive manner, each embodiment focuses on the difference from other embodiments, and the same and similar parts between the embodiments may refer to each other.

Several examples are used for illustration of the principles and implementation methods of the present invention. The description of the embodiments is used to help illustrate the method and its core principles of the present invention. In addition, those skilled in the art can make various modifications in terms of specific embodiments and scope of application in accordance with the teachings of the present invention. In conclusion, the content of this specification shall not be construed as a limitation to the invention.

What is claimed is:

1. An inorganic mass spectrometer, wherein the inorganic mass spectrometer comprises:
a multi-charge state ion source, used for generating a strong current ion beam of multivalent charge states (3+ or over 3+), wherein the strong current ion beam comprises: a constant particle beam, a micro particle beam, a trace particle beam, and an ultra-trace particle beam, and the ultra-trace particle beam comprises an ultra-trace isotope and an ultra-trace background;
a front-end analysis system, connected with the multi-charge state ion source and used for screening the constant particle beam, the micro particle beam, and the trace particle beam, absorbing and measuring the constant particle beam, the micro particle beam, and the trace particle beam, and outputting the ultra-trace particle beam;
a back-end analysis system, connected with the front-end analysis system and used for eliminating the ultra-trace background in the ultra-trace particle beam; and
an ion detector, connected with the back-end analysis system and used for receiving the ultra-trace isotope and measuring the ultra-trace isotope.

2. The inorganic mass spectrometer according to claim 1, wherein the multi-charge state ion source is a cyclotron resonance ion source, and can generate a strong current ion beam of multivalent charge states (3+ or over 3+) for all elements from H to Pu, actinide elements, and transactinide elements.

3. The inorganic mass spectrometer according to claim 1, wherein the front-end analysis system comprises:
an accelerating section, connected with the multi-charge state ion source and used for accelerating the strong current ion beam;
a front-end analyzer, respectively connected with the accelerating section and the back-end analysis system, and used for separating the constant particle beam, the micro particle beam, and the trace particle beam from the ultra-trace particle beam, and outputting the ultra-trace particle beam into the back-end analysis system; and
an ion receiver, disposed at an output end of the front-end analyzer and used for absorbing and measuring the constant particle beam, the micro particle beam, and the trace particle beam.

4. The inorganic mass spectrometer according to claim 3, wherein the accelerating section is a strong current single-stage electrostatic accelerating tube, and the accelerating tube has a beam intensity in a range of 0.1 μA-5000 μA, and an operating voltage of 10 kV-400 kV.

5. The inorganic mass spectrometer according to claim 3, wherein the front-end analyzer is any one or a combination of any two of a magnetic analyzer, an electrostatic analyzer, a quadrupole analyzer, or a flight time analyzer.

6. The inorganic mass spectrometer according to claim 3, wherein the ion receiver is a set of Faraday cups.

7. The inorganic mass spectrometer according to claim 1, wherein the back-end analysis system comprises: a first electrostatic analyzer, an energy absorption film, a magnetic analyzer, and a second electrostatic analyzer, wherein an input end of the first electrostatic analyzer is connected with an output end of the front-end analysis system, and the energy absorption film is fixed between an output end of the first electrostatic analyzer and an input end of the magnetic analyzer; and an output end of the magnetic analyzer is connected with an input end of the second electrostatic analyzer, and an output end of the second electrostatic analyzer is connected with the ion detector.

8. The inorganic mass spectrometer according to claim 1, wherein the back-end analysis system comprises: an electrostatic analyzer, an energy absorption film, and a speed selector, wherein an input end of the electrostatic analyzer is connected with an output end of the front-end analysis system, and the energy absorption film is fixed between an output end of the electrostatic analyzer and an input end of the speed selector; and an output end of the speed selector is connected with the ion detector.

9. The inorganic mass spectrometer according to claim 1, wherein the ion detector is a solid detector or a gas detector.
